(19) United States
(12) Patent Application Publication
(10) Pub. No.: US 2015/0029983 A1
(43) Pub. Date: Jan. 29, 2015

(54) RADIO SYSTEM, RADIO BASE STATION, AND MANAGEMENT APPARATUS

(71) Applicant: Hitachi Kokusai Electric Inc., Tokyo (JP)

(72) Inventor: Yukinao Kimoto, Tokyo (JP)

(21) Appl. No.: 14/388,059

(22) PCT Filed: Mar. 7, 2013
(86) PCT No.: PCT/JP2013/056313

§ 371 Date: Sep. 25, 2014

(30) Foreign Application Priority Data
Apr. 11, 2012 (JP) 2012-089981

(51) Int. Cl. H04W 72/08; H04W 8/00; H04W 68/02

(52) U.S. Cl. CPC H04W 72/082; H04W 68/02; H04W 8/005; H04W 88/08
USPC 370/329

(57) ABSTRACT

A new base station transmits position information to a TVWSDB device and receives channel information of TV white space from the TVWSDB device. The TVWSDB apparatus instructs existing base stations to arrange that the respective CPE terminals that are the nearest in distance to the new base station perform CBP bursts for channels reported to the new base station. The CPE terminals then perform the CBP bursts according to a schedule established for the existing base stations. The new base station searches for and finds a cell having the same standard as itself on the basis of the burst signals of the CPE terminals and shares the channel of the cell having the same standard as itself with the existing base stations.

### FIELD OF THE INVENTION

The present invention relates to a radio system, a radio base station and a management apparatus capable of performing radio communications by sharing a channel between radio base stations.

### BACKGROUND OF THE INVENTION

Radio communications are performed in a frequency band allocated in advance, but the bandwidth is getting insufficient with an increase of data traffic and an increase in radio devices in recent years. On the other hand, there is a frequency band for television broadcasting which has a relatively wide bandwidth in order to prevent interference between broadcasting stations.

For example, in digital terrestrial broadcasting in Japan, frequency allocation is performed on broadcasting stations in each region such that a bandwidth of 240 MHz is divided into 40 physical channels from 13ch (470 MHz) to 52ch (710 MHz), each having a width of 6 MHz. FIG. 12 shows part of a channel plan for digital terrestrial broadcasting in Japan. For example, in Tokushima, three channels of 34ch, 40ch and 31ch are used, and the remaining 37 channels are not used.

Thus, only part of channels allocated in advance for digital terrestrial broadcasting is actually used, and most channels are vacant channels which are not used.

Therefore, there has been studied a technique for performing radio communications using vacant channels (TV white space) in television frequency bands. For example, in the IEEE 802.22 working group, a WRAN (Wireless Regional Area Network) standard using the TV white space has been developed (see Non-patent Document 1).

Non-patent Document 1: IEEE P802.22/D3.0, March 2011 Draft Standard for Wireless Regional Area Networks Part 22: Cognitive Wireless RAN Medium Access Control (MAC) and Physical Layer (PHY) specifications: Policies and procedures for operation in the TV Bands

In addition to the IEEE 802.22 working group, there are IEEE 802.11af, IEEE 802.15.4m, TD-LTE and the like as the working group for the purpose of using the TV white space. That is, it is necessary to share the TV white space among various radio systems in different standards.

However, when the same channel is used in different standards, e.g., IEEE 802.22 and IEEE 802.11af, IEEE 802.22 in a Time Division Duplex (TDD) mode starts transmission at a predetermined timing even during transmission of IEEE 802.11af without performing carrier sensing for every frame, which causes co-channel interference. On the other hand, IEEE 802.11af in a CSMA/CA (Carrier Sense Multiple Access/Collision Avoidance) mode performs carrier sensing but starts transmission at a TTG (Transmit/Receive Transition Gap) or RTG (Receive/Transmit Transition Gap), which is a period in which there is no radio wave in the TDD mode of IEEE 802.22, thereby causing co-channel interference with frames of IEEE 802.22 which starts transmission after the TTG or the RTG.

Further, as the cause of co-channel interference, there is a so-called hidden terminal problem. For example, FIG. 13 is a diagram showing a state in which channel interference occurs due to a hidden terminal.

In the illustrated case, access points AP1 and AP2 that are radio base stations are operated in the same channel. CPE (Customer Premises or portable Equipment) terminals 6-1 and 6-2 are close to each other, but the CPE terminal 6-1 is present in a cell of the access point AP1 and the CPE terminal 6-2 is present in a cell of the access point AP2. There is a shielding object B between the access points AP1 and AP2, so that the radio waves from the access point AP1 cannot reach the access point AP2 and vice versa. That is, the access point AP1 (AP2) is a hidden terminal for the access point AP2 (AP1). Therefore, in FIG. 13, if the access points AP1 and AP2 perform data transmission to the CPE terminals 6-1 and 6-2, respectively, at the same timing, there occurs a hidden terminal problem that the radio waves of the access points AP1 and AP2 interfere with each other in the CPE terminals 6-1 and 6-2.

That is, as in the case of using the TV white space, when various radio systems in different standards perform radio communications by sharing a predetermined frequency band, there is a problem that co-channel interference easily occurs between the radio systems.

### SUMMARY OF THE INVENTION

In view of the above, the present invention provides a technique in which co-channel interference hardly occurs between radio systems when various radio systems in different standards perform radio communications by sharing a predetermined frequency band.

In accordance with an aspect of the present invention, there is provided a radio system including: a plurality of radio base stations for performing radio communications by using a channel among a plurality of channels; and a plurality of terminal devices for performing the radio communications with the radio base stations.

The radio system further includes: a retrieving unit for retrieving a terminal device which is closest to one of the radio base stations for each of one or more of the channels when determining a channel to be used by the one of the radio base stations; and an instruction unit for instructing the terminal device retrieved by the retrieving unit to transmit a notification signal.

The one of the radio base stations includes a channel determining unit configured to determine the channel to be used based on a reception state of the notification signal from the terminal device.

The channel determining unit of the one of the radio base stations may search for a vacant channel among the plurality of channels.

The channel determining unit may determine, when there is a vacant channel, the vacant channel as the channel to be used, and the channel determining unit may determine, when there is no vacant channel, a channel of either of the notification signal and the control signal which comply with a same standard that the one of the radio base stations complies with as the channel to be used based on the received notification signal.

The channel determining unit of the one of the radio base stations may determine, when the notification signal is received, that a standard is same to what the one of the radio base stations complies with, and the channel determining unit of the one of the radio base stations may determine, when the notification signal is not received, that the standard is different from what the one of the radio base stations complies with.

When using the channel of the notification signal which complies with the same standard that the one of the radio base stations complies with, the one of the radio base stations performs, via the terminal device from which the notification signal is transmitted, a setting process for sharing the channel to be used with other radio base stations using the channel to be used.

In accordance with another aspect of the present invention, there is provided a radio base station for use in a radio system which includes a plurality of radio base stations for performing radio communications by using a channel among a plurality of channels, a plurality of terminal devices for performing the radio communications with the radio base stations, a retrieving unit for retrieving a terminal device which is closest to one of the radio base stations for each of one or more of the channels when determining a channel to be used by the one of the radio base stations, and an instruction unit for instructing the terminal device retrieved by the retrieving unit to transmit a notification signal.

The radio base station includes: a channel determining unit configured to determine the channel to be used based on a reception state of the notification signal from the terminal device.

In accordance with still another aspect of the present invention, there is provided a management apparatus for use in a radio system which includes a plurality of radio base stations for performing radio communications by using a channel among a plurality of channels, and a plurality of terminal devices for performing the radio communications with the radio base stations, at least one of the radio base stations containing a channel determining unit configured to determine a channel to be used based on reception state of one or more notification signals from one or more of the terminal devices.

The management apparatus includes: a retrieving unit for retrieving a terminal device which is closest to one of the radio base stations for each of one or more of the channels when determining a channel to be used by the one of the radio base stations; and an instruction unit for instructing the terminal device retrieved by the retrieving unit to transmit the notification signal.

In accordance with the aspects of the present invention, it is possible to prevent co-channel interference between radio systems when various radio systems in different standards perform radio communications by sharing a predetermined frequency band.

### BRIEF DESCRIPTION OF THE DRAWINGS

FIG. 1 shows the whole configuration of a radio system in accordance with an embodiment of the present invention.

FIG. 2 is a diagram showing a state in which a new base station shown in FIG. 1 finds an operation channel from a TV white space.

FIG. 3 is a diagram showing a state in which an existing base station and the new base station shown in FIG. 1 share radio frames.

FIG. 4 is a sequence diagram showing a state in which the existing base station and the new base station shown in FIG. 1 share radio frames.

FIG. 5 is a diagram illustrating a frame structure of IEEE 802.22.

FIG. 6 is a diagram showing a state in which the existing base station and the new base station shown in FIG. 1 transmit frames in a time division manner.

FIG. 7 is a diagram showing a cell in which CPE terminals shown in FIG. 1 are not uniformly distributed.

FIG. 8 is a flowchart showing a processing flow of the radio system shown in FIG. 1.

FIG. 9 is a diagram showing a configuration of a REQUEST message of the new base station shown in FIG. 1.

FIG. 10 is a diagram showing a configuration of an INDICATION message of a TVWSDB device shown in FIG. 1.

FIG. 11 is a flowchart showing a flow of an operation channel determining process of the new base station shown in FIG. 1.

FIG. 12 shows part of a channel plan for digital terrestrial broadcasting in Japan.

FIG. 13 is a diagram showing a conventional state in which channel interference occurs due to a hidden terminal.

### DETAILED DESCRIPTION OF THE EMBODIMENTS

Hereinafter, an embodiment of the present invention will be described in detail with reference to the accompanying drawings.

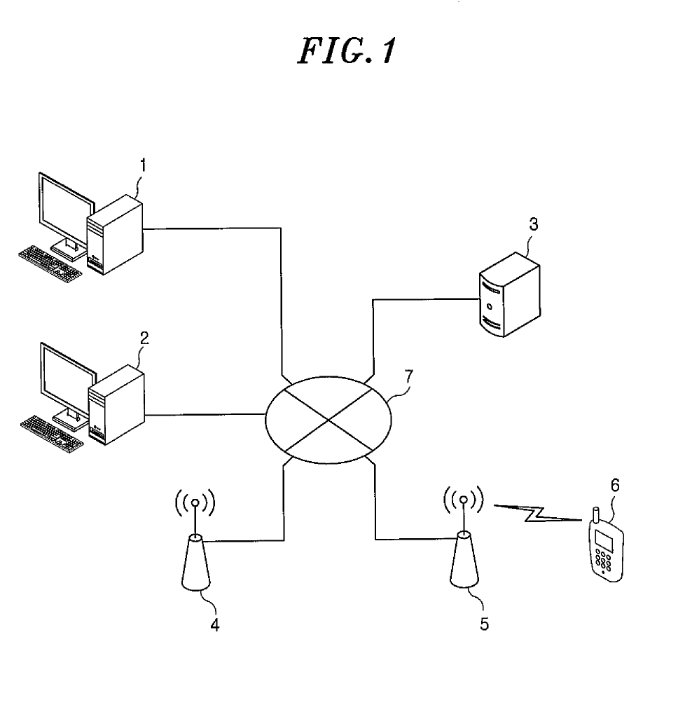

FIG. 1 shows the entire configuration of a radio system in accordance with an embodiment of the present invention.

The radio system includes a network management system (NMS) 1, a network control system (NCS) 2, a television white space database (TVWSDB) device 3, a new base station 4, an existing base station 5, and a customer premises or portable equipment (CPE) terminal 6.

The network management system 1, the network control system 2, the TVWSDB device 3, the new base station 4 and the existing base station 5 are connected through an IP (Internet Protocol) network 7. Further, the existing base station 5 and the CPE terminal 6 are connected via radio waves.

In FIG. 1, each of the new base station 4, the existing base station 5 and the CPE terminal 6 has been illustrated as a single unit for the sake of simplicity. However, one or more (1 to n: n is a natural number) new base stations 4 and one or more (1 to m: m is a natural number) existing base stations 5 may be provided, and one or more (1 to l: l is a natural number) CPE terminals 6 may be provided.

The network management system 1 performs the management of the network. For example, the network management system 1 performs the maintenance for security of the network, the management of performance of other devices constituting the network, and the like.

The network control system 2 controls QoS (Quality of Service) in the network.

The TVWSDB device 3 has a TV white space database (TVWSDB, hereinafter, simply referred to as a DB) to store channel information used by a TV station for each region, position information of the existing base station 5, channel information of a TV white space used by the existing base station 5, position information of the CPE terminal 6, and channel information of a TV white space used by the CPE terminal 6. For simplicity of description, all information will be described as being stored in one region, but may be stored separately in a plurality of regions.

The CPE terminal 6 is present in the cell of the existing base station 5 to perform radio communications under the centralized control of the existing base station 5. Further, the CPE terminal 6 has a GPS receiver to acquire its own position information via the GPS receiver and transmit the position information to the existing base station 5 supporting the CPE terminal 6.

The existing base station 5 complies with standards (e.g., IEEE 802.22, IEEE 802.11af, IEEE 802.15.4m, TD-LTE or the like) that can use a TV white space to perform radio communications by using channels of the TV white space. That is, the existing base station 5 performs radio communications by using one of available channels. Further, the existing base station 5 has a GPS receiver to acquire its own position information therefrom.

Further, the existing base station 5 performs centralized control of one or more CPE terminals 6 present in the cell of the existing base station 5 to perform radio communications with the CPE terminals 6 in the cell via the channel of the TV white space. Further, in the case of using the channel of the TV white space, the existing base station 5 registers, in the TVWSDB device 3, its own position information, the position information transmitted from each of the CPE terminals 6 supported by the existing base station 5 and the using channel in the TV white space.

The new base station 4 is a base station which tries to newly start an operation by using a channel of the TV white space and performs radio communications by using one of available channels. In the present embodiment, description is made by assuming that the new base station 4 complies with, e.g., the IEEE 802.22.

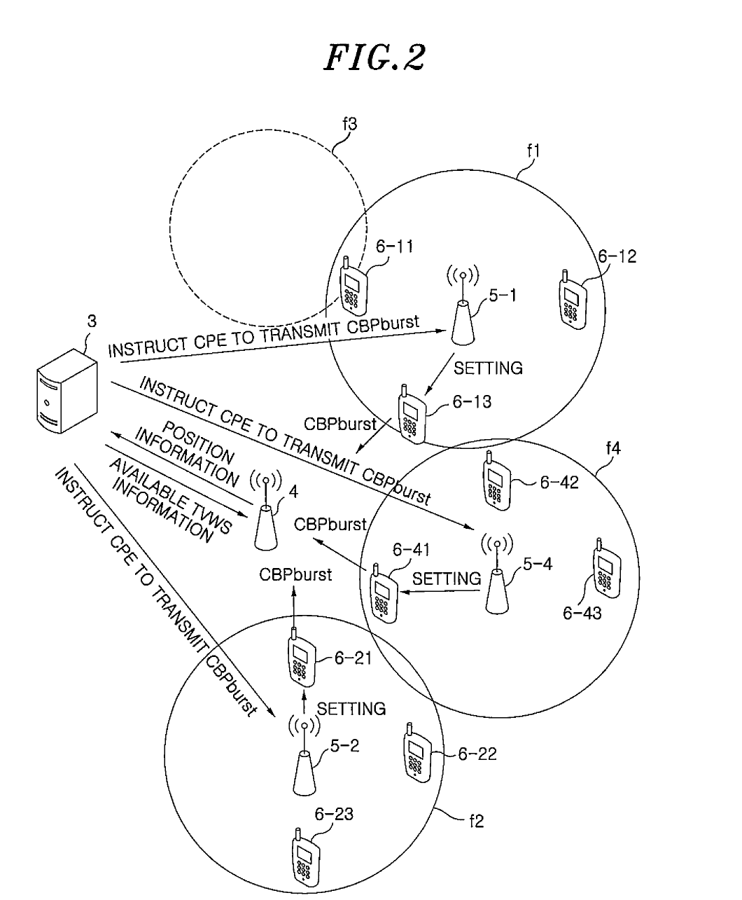

A process in which the new base station 4 finds an operation channel from the TV white space will be described in detail with reference to FIG. 2.

When power is ON, the new base station 4 acquires its own position information via the GPS receiver and notifies the TVWSDB device 3. Upon receiving the position information from the new base station 4, the TVWSDB device 3 retrieves, from the DB, channel information of the TV white space of a region corresponding to the position information of the new base station 4 and notifies the new base station 4. In FIG. 2, channels f1 to f4 are notified as the channel information of the white space that can be used by the new base station 4.

At the same time, the TVWSDB device 3 retrieves, from the DB, the CPE terminal 6 which is closest to the new base station 4 for each channel notified to the new base station 4 on the basis of the position information of the new base station 4. Then, the TVWSDB device 3 retrieves, from the DB, the existing base station 5 which uses the same channel as each CPE terminal 6 that has been retrieved and issues an instruction to the existing base station 5 having the retrieved CPE terminal 6 in the cell such that the CPE terminal 6 which is closest to the new base station 4 in each channel transmits a notification signal (e.g., a broadcast signal or a burst signal, a CBP burst in this case). In FIG. 2, the TVWSDB device 3 issues instructions to existing base stations 5-1, 5-2 and 5-4 of the channels f1, f2 and f4 such that CPE terminals 6-13, 6-21 and 6-41 transmit CBP bursts, respectively.

Thus, upon receiving the instruction from the TVWSDB device 3, each existing base station 5 schedules CBP burst transmission by the CPE terminal 6, which is designated by the TVWSDB device 3. Then, the CPE terminal 6 transmits the CBP burst according to the schedule. The CBP burst is a burst signal which is transmitted intermittently for a time sufficient to receive the CBP burst at the new base station 4.

Further, the TVWSDB device 3 may retrieve the CPE terminal 6 in a neighboring region (e.g., in a predetermined range) or the CPE terminal 6 whose position is registered in the existing base station 5 in the neighboring region based on the position information of the new base station 4 without retrieving from the DB the CPE terminal 6 for each channel notified to the new base station 4. By performing retrieval for each channel, it is possible to more reliably prevent interference due to a hidden terminal or the like. Meanwhile, by narrowing a range to be retrieved based on the position information of the new base station 4, it is possible to improve efficiency.

Thus, as a management apparatus of the radio system, when the new base station 4 determines a channel to use, the TVWSDB device 3 functions as a retrieving unit for performing a retrieving process to retrieve from the DB the CPE terminal 6 which is closest to the new base station 4 for at least one channel among the channels of the white space that can be used by the new base station 4.

Further, the TVWSDB device 3 functions as an instructing unit for performing an instructing process. That is, the TVWSDB device 3 retrieves from the DB the existing base station 5 which uses the same channel as each CPE terminal 6 retrieved by the retrieving unit or the existing base station 5 in which the position of each CPE terminal 6 is registered. Then, the TVWSDB device 3 issues an instruction to the existing base station 5 having the retrieved CPE terminal 6 in the cell such that the CPE terminal 6 which is closest to the new base station 4 in each channel transmits the CBP burst.

Meanwhile, for each channel in the channel information of the TV white space obtained from the TVWSDB device 3, the new base station 4 investigates (1) whether it is a vacant channel or not, or (2) whether the radio waves of the channel are in the same standard as itself if it is not a vacant channel.

(1) Whether the channel is a vacant channel or not is investigated as follows. The new base station 4 measures a RSSI (Received Signal Strength Indicator) of the channel and determines that it is a vacant channel if the RSSI is lower than a predetermined specific value, and determines that it is a channel in use if the RSSI is higher than or equal to the predetermined specific value.

(2) Whether the radio waves of the channel are in the same standard as the new base station 4 is investigated as follows. The new base station 4 complying with the IEEE 802.22 determines that the radio waves of the channel are in the same standard as itself if the CBP burst from the CPE terminal 6 can be received (demodulated) through the channel, or a control signal (SCH (Superframe Control Header) in this case) from the existing base station 5 can be received (demodulated) through the channel. That is, the new base station 4 determines a channel to use based on the reception state of the CBP burst and/or the reception state of the control signal from the existing base station 5.

Further, in the case where the radio waves of the channel are in the standard different from that of the new base station 4, the new base station 4 cannot receive (demodulate) radio waves from radio systems using the channel of which the RSSI is equal to or greater than a predetermined specific value. Based on this, the new base station 4 determines that the channel is used in the standard different from itself.

Further, although the radio waves of the channel are in the same standard as the new base station 4, if the radio waves are subject to some interference, the new base station 4 cannot receive (demodulate) the radio waves (CBP burst or the like). Thus, also in this case, the channel is regarded as the channel of a cell in the standard different from that of the new base station 4 and is excluded from the determination of the operation channel.

That is, the cell in the same standard as the new base station 4 transmits the radio waves that can be received (demodulated) at the new base station 4. On the other hand, the cell in the standard different from the new base station transmits the radio waves that cannot be received (demodulated) at the new base station 4.

Then, upon completion of the investigation for all channels notified by the TVWSDB device 3, the new base station 4 determines an operation channel based on the investigation results. That is, if there is a channel that is not allocated to other radio systems, the new base station 4 determines the channel as the operation channel. In FIG. 2, the vacant channel f3 is determined as the operation channel. Further, if there is a plurality of vacant channels, a channel of the lowest RSSI is determined as the operation channel of the new base station 4. This is because the radio waves are clear when the RSSI is lower.

On the other hand, if all of the notified channels of the TV white space have been used by other radio systems (if channel f3 does not exist in in FIG. 2), the new base station 4 determines whether there is a cell in the same standard as itself on the basis of the investigation results or not. When there is a cell in the same standard as the new base station 4, the new base station 4 shares the channel with other radio systems because there is no vacant channel.

If there is no cell in the same standard as the new base station 4, the new base station 4 stops the operation. This is because co-channel interference is likely to occur if radio systems having different standards use the same channel as described above.

On the other hand, if there is a cell in the same standard as the new base station 4, the new base station 4 determines the channel of the cell as an operation channel. For example, in the illustrated case, if the existing base station 5-4 is in the same IEEE 802.22 as the new base station 4, the channel f4 is determined as an operation channel. Further, if there is a plurality of cells in the same standard as the new base station 4, a channel of the highest RSSI is determined as an operation channel. This is because the new base station 4 in the IEEE 802.22 is easy to perform the time division in radio frames when the RSSI of the channel is high.

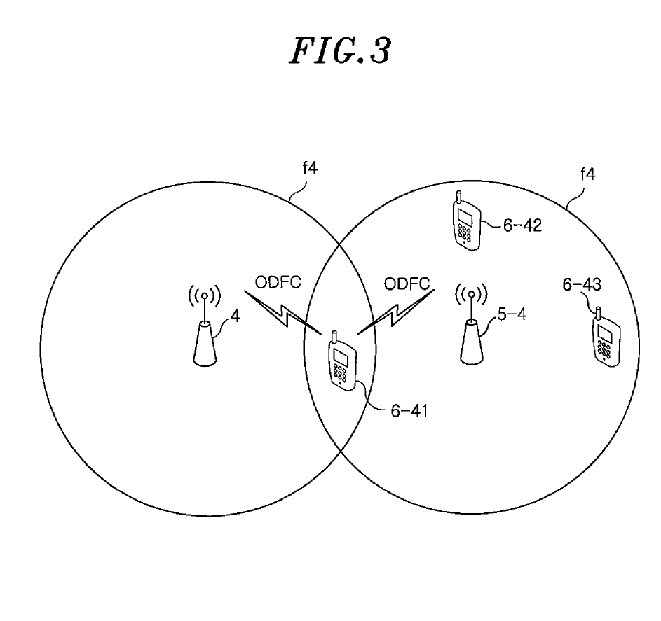

Then, as shown in FIG. 3, the new base station 4 performs adjustment to share the channel with the existing base station 5-4 via the CPE terminal 6-41, from which the CBP burst has been received during the investigation of channels, as the CPE terminal 6 which is closest to the new base station 4 in the cell of the operation channel. The CPE terminal 6-41 is present in the region where the cell of the new base station 4 overlaps with the cell of the existing base station 5-4. In the IEEE 802.22, it has been defined that in the cognitive radio communications, allocation of radio frames is performed using an ODFC (On-Demand Frame Contention) protocol when the new base station 4 and the existing base station 5-4 share the channel.

Thus, in the transmission and reception of the ODFC protocol for the allocation of radio frames between the new base station 4 and the existing base station 5-4, the new base station 4 performs communications via a relay of the CPE terminal 6-41 which is closest to the new base station 4. Since the CPE terminal 6-41 is the CPE terminal 6 which is closest to the new base station 4 in the cell of the channel, it can relay the communications between the new base station 4 and the existing base station 5-4 without causing a hidden terminal problem.

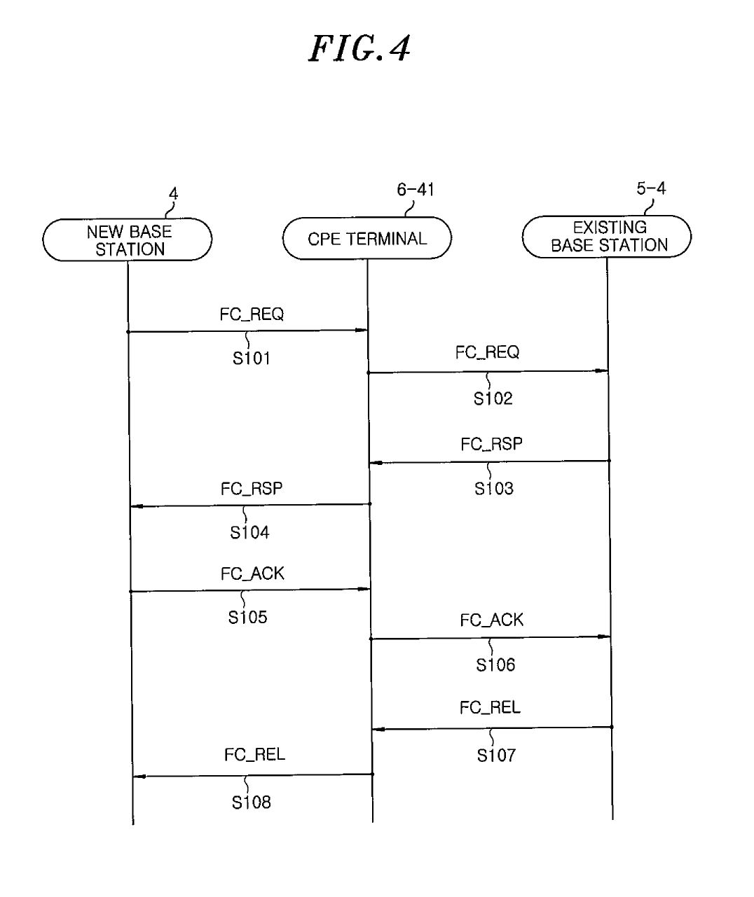

Further, a sequence for allowing the new base station 4 to share radio frames of one channel with the existing base station 5 has been set forth in the IEEE 802.22. Specifically, a setting process for allowing the new base station 4 and the existing base station 5-4 to share the channel via the CPE terminal 6-41 is performed according to a sequence diagram shown in FIG. 4.

First, in step S101, the new base station 4 transmits FC_REQ to the CPE terminal 6-41 as a relay destination. In step S102, the CPE terminal 6-41 transmits the received FC_REQ to the existing base station 5-4. In step S103, the existing base station 5-4 having received the FC_REQ transmits FC_RSP to the CPE terminal 6-41. In step S104, the CPE terminal 6-41 transmits the FC_RSP to the new base station 4. In step S105, the new base station 4 transmits FC_ACK to the CPE terminal 6-41. In step S106, the CPE terminal 6-41 transmits the FC_ACK to the existing base station 5-4. In step S107, the existing base station 5-4 transmits FC_REL to the CPE terminal 6-41. Then, in step S108, the CPE terminal 6-41 transmits the FC_REL to the new base station 4, and the process is completed.

Thus, the existing base station 5-4 is shifted from a normal mode in which the channel is used alone to a self-coexistence mode in which the channel is shared to share the channel with the new base station 4.

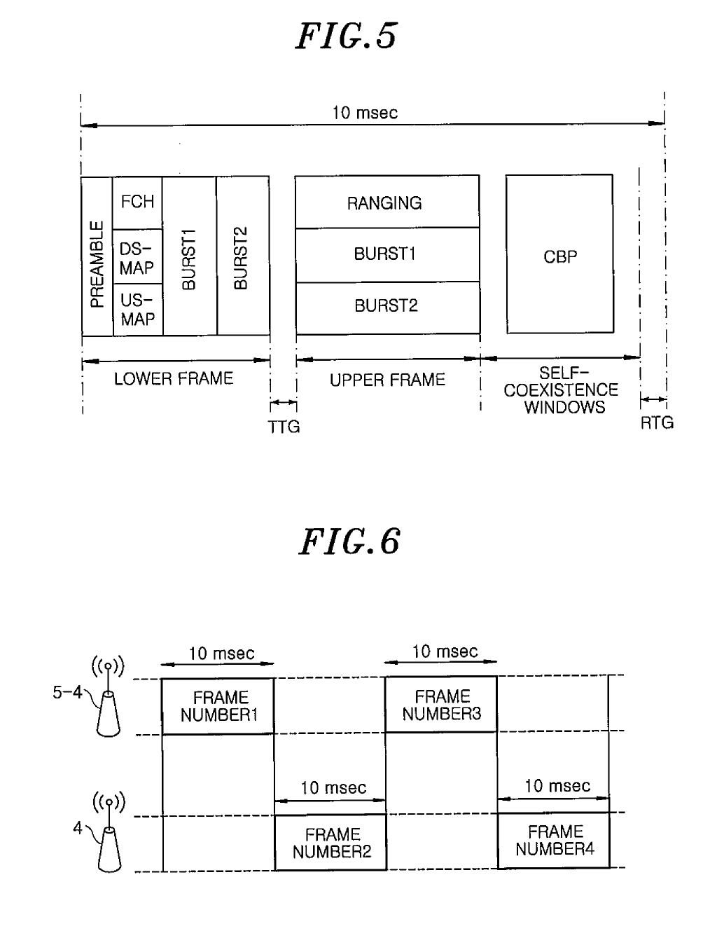

FIG. 5 is a diagram illustrating a frame structure of IEEE 802.22. FIG. 6 is a diagram showing a state in which the new base station 4 and the existing base station 5-4 transmit frames in a time division manner while sharing the channel. Thus, the new base station 4 and the existing base station 5-4 alternately transmit frames every 10 msec in a time division manner. Further, the new base station 4 may interrupt a channel which is already shared with a plurality of existing base stations 5. Thus, in the present embodiment, the CPE terminal 6 which is closest to the new base station 4 for each channel transmits the CBP burst.

However, in IEEE 802.22, it is not specified which one among the existing base station 5 and CPE terminals 6 should transmit the CBP burst in order to inform the surroundings about the presence of the cell.

In case where the existing base station 5 transmits the CBP burst, there is a possibility that the CBP burst does not reach the base station of the adjacent cell, thereby causing the hidden terminal problem. This also applies if the existing base station 5 transmits only the SCH.

On the other hand, in case where the existing base station 5 has set all CPE terminals 6 in the cell to transmit the CBP bursts, since the maximum number of terminals that can be supported by the existing base station 5 is 512, it takes about 5.12 seconds until all CPE terminals 6 in the cell complete the transmission of CBP bursts. In this case, since the CPE terminal 6, which is present in the vicinity of the existing base station 5 and close to the center of the cell, also transmits the CBP burst, it is inefficient when considering the purpose of informing the surroundings about the presence of the cell.

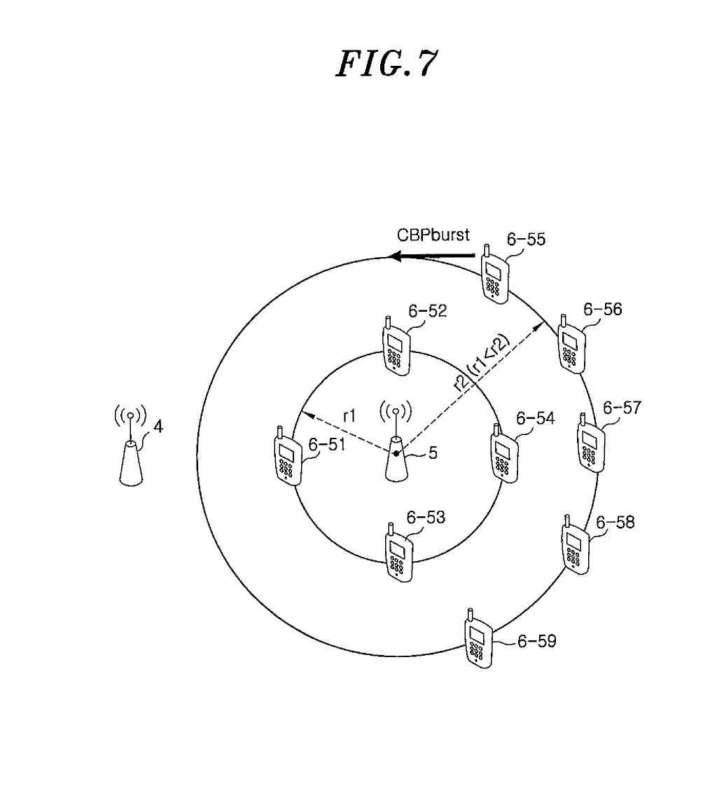

On the other hand, it is assumed that the CPE terminals 6 (e.g., the CPE terminal 6 with a low reception level for the notification information transmitted from the existing base station 5, the CPE terminal 6 with a large delay in the ranging of IEEE 802.22, or the like) which are distant from the existing base station 5 are scheduled to transmit the CBP bursts. In this case, it is preferable that the CPE terminals 6 are uniformly distributed in the cell of the existing base station 5. However, generally, as shown in FIG. 7, the CPE terminals 6 are less likely to be uniformly distributed. Even if the CBP burst is transmitted from the farthest CPE terminal 6, e.g., the CPE terminal 6-55, there occurs a problem that the CBP burst does not reach the (adjacent) cell of the new base station 4.

Therefore, in the present embodiment, the TVWSDB device 3 retrieves the CPE terminal 6 which is closest to the new base station 4 in each channel (in the cell of each existing base station 5) of the TV white space corresponding to the position information of the new base station 4, and instructs only the retrieved CPE terminal 6 to transmit the CBP burst. If there is no vacant channel, the new base station 4 finds the channel used in the radio system which has the same standard as itself to share the channel with the existing base station 5 via the CPE terminal 6 from which the CBP burst has been received. As a result, the new base station 4 can reliably detect the presence of the adjacent cell, and it is possible to prevent co-channel interference without the hidden terminal.

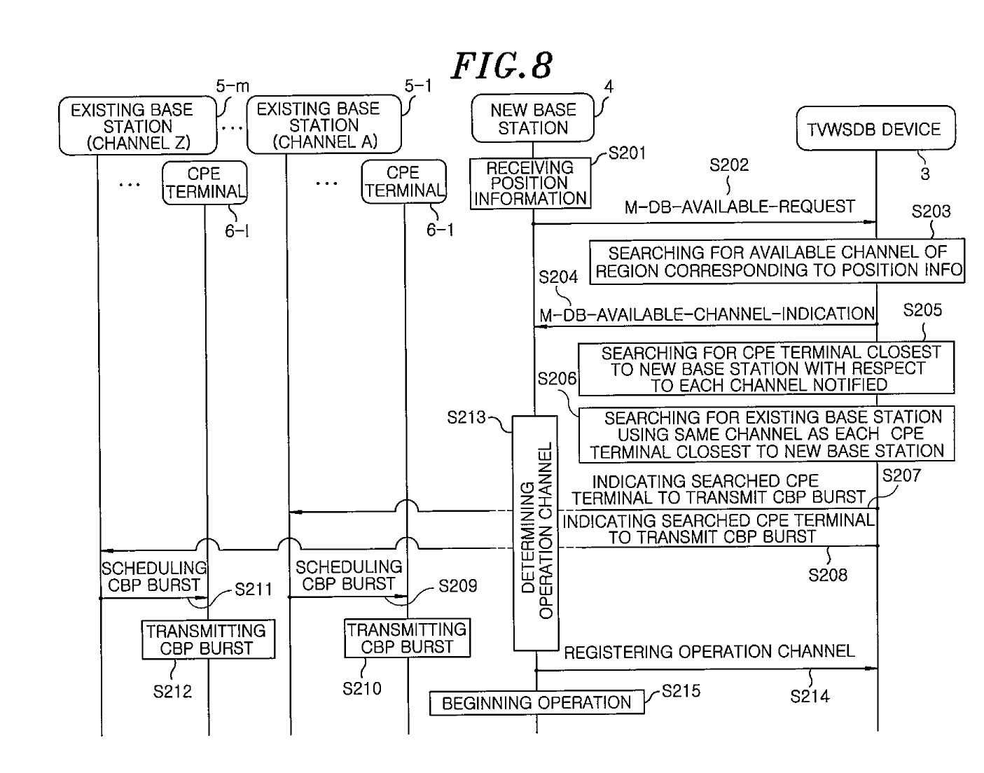

Next, a processing flow of the entire radio system will be described in detail with reference to FIG. 8.

First, in step S201, the new base station 4 receives its own position information via the GPS receiver. Then, in step S202, the new base station 4 transmits a REQUEST message including the position information and the time when the position information is received to the TVWSDB device 3.

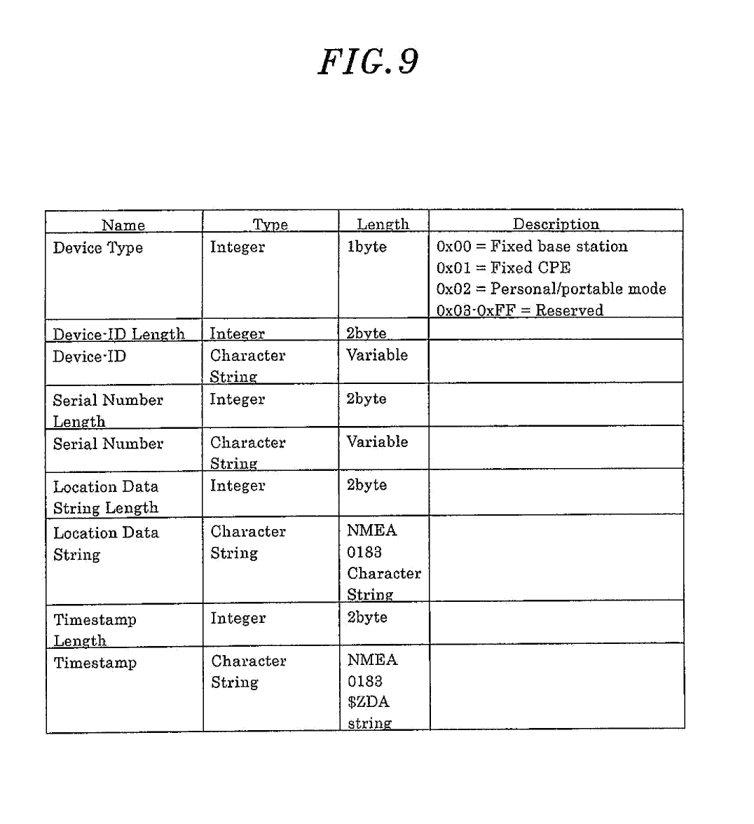

FIG. 9 is a diagram showing a configuration of the REQUEST message. The position information of the new base station 4 is stored in the “Location Data String”, and the time information is stored in the “Timestamp”.

Referring back to FIG. 8, in step S203, the TVWSDB device 3 having received the REQUEST message retrieves from the DB available channels of TV white space in a region corresponding to the position information of the new base station 4. Then, in step S204, the TVWSDB device 3 transmits an INDICATION message storing the retrieved channel information of the TV white space to the new base station 4.

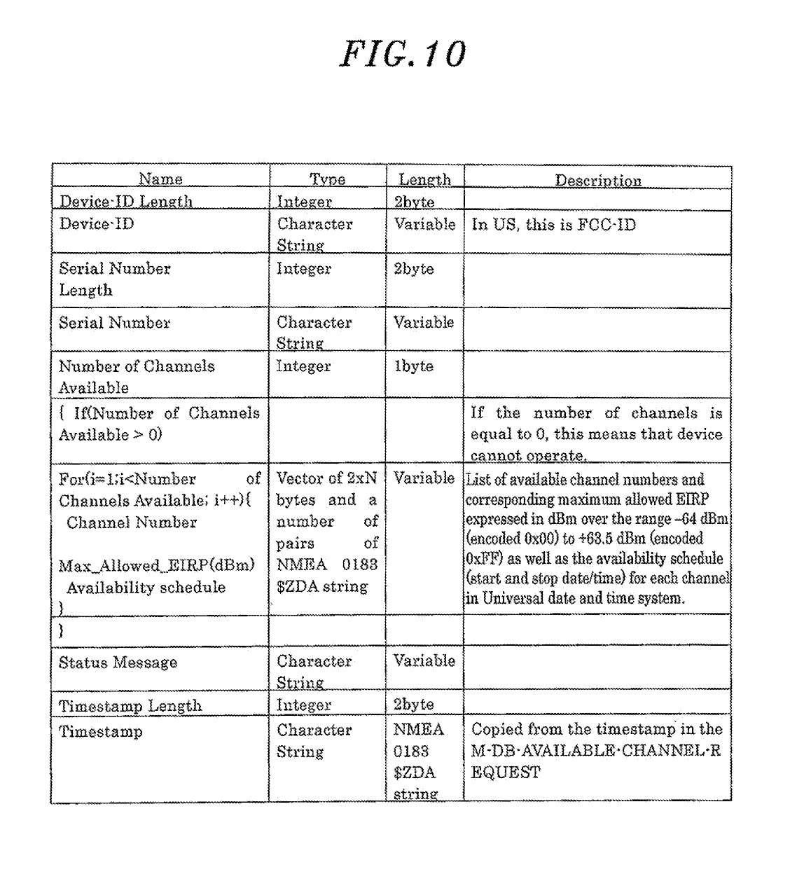

FIG. 10 is a diagram showing a configuration of the INDICATION message. The INDICATION message includes the “Number of Channels Available” in which the number of available channels or the available channel information of the TV white space is stored.

Referring back to FIG. 8, in step S205, for each available channel of the TV white space notified to the new base station 4, if CPE terminals 6 using the channel are present, the TVWSDB device 3 retrieves from the DB a CPE terminal 6 which is closest to the new base station 4 among the CPE terminals 6. Then, in step S206, the TVWSDB device retrieves the existing base station 5 using the same channel as the retrieved CPE terminal 6, i.e., the existing base station 5 having the retrieved CPE terminal 6 in the cell. Then, in steps S207 and S208, the TVWSDB device 3 instructs the existing base station 5 of each channel such that the CPE terminal 6 which is closest to the new base station 4 in each channel transmits the CBP burst. In this case, in the existing base stations 5 having received the instructions from the TVWSDB device 3, those having the same standard as the new base station 4 and those having the standard different from the new base station 4 are mixed.

In steps S209 and S211, the existing base stations 5-1 and 5-m perform scheduling such that the CPE terminals 6-1 and 6-1 which are closest to the new base station 4 transmit burst signals, respectively. In steps S210 and S212, the CPE terminals 6-1 and 6-1 (CPE terminals which are closest to the new base station 4) scheduled by the existing base station 5 transmit the CBP bursts according to the schedule.

Meanwhile, in step S213, the new base station 4 performs an operation channel determining process based on the channel information of the TV white space notified by the TVWSDB device 3. The operation channel determining process will be described later. In step S214, the new base station 4 registers the determined operation channel in the TVWSDB device 3. Then, in step S215, the new base station 4 starts an operation using the determined operation channel and the process is completed.

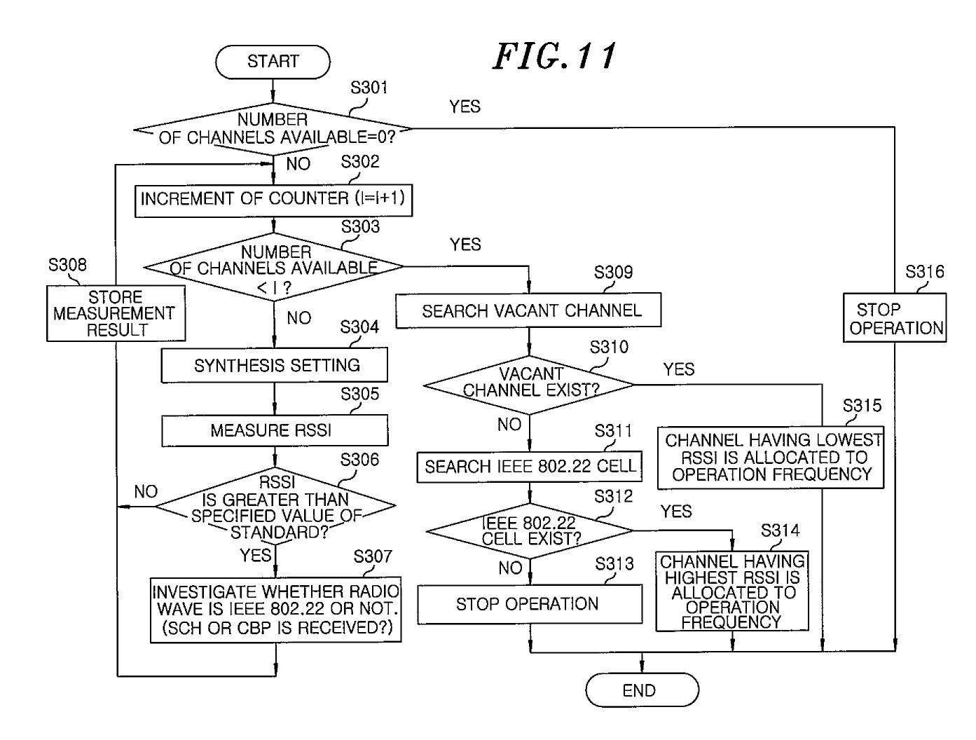

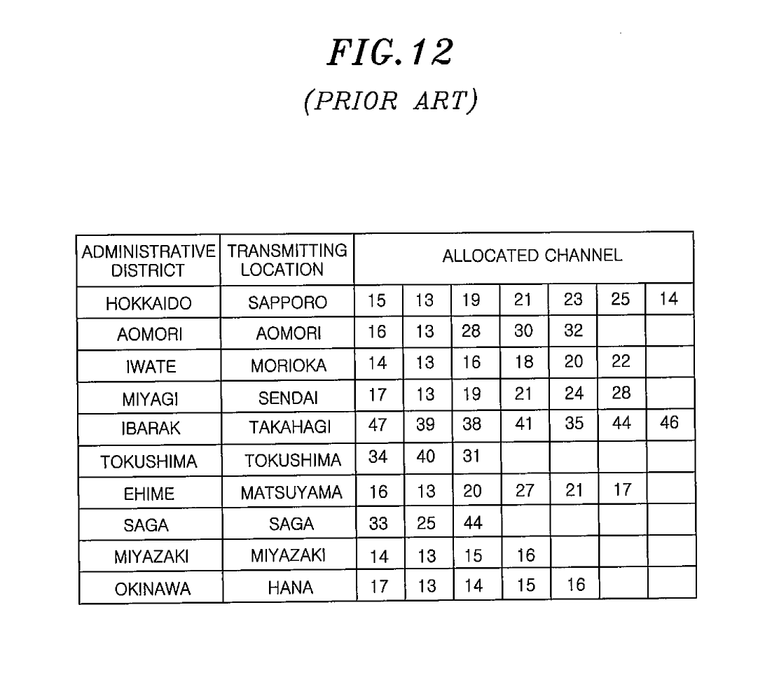

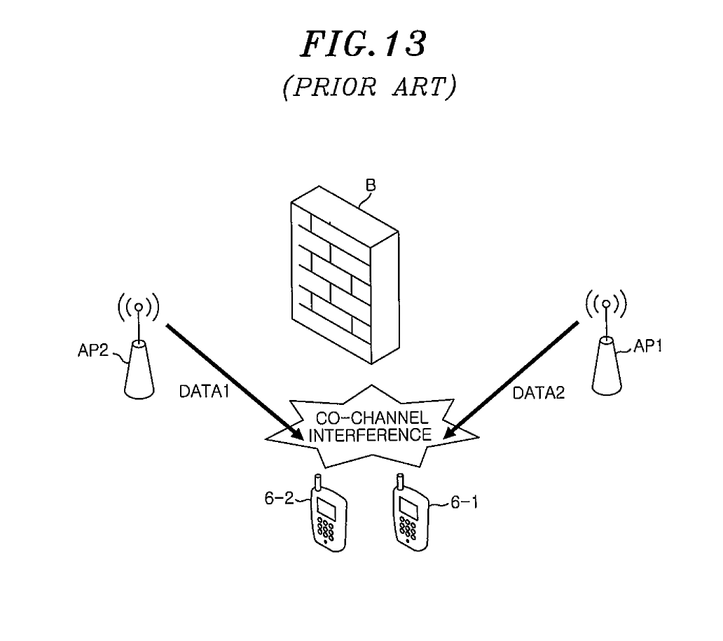

Next, a flow of the operation channel determining process of the new base station 4 will be described with reference to FIG. 11.

First, in step S301, for the INDICATION message notified by the TVWSDB device 3, the new base station 4 determines whether the number of available channels of the TV white space in the region of the new base station 4 is zero (i.e., Number Of Channels Available=0). If “Yes” in step S301, the new base station 4 stops an operation in step S316, and the process is completed.

On the other hand, if “No” in step S301, in step S302, the new base station 4 increments a counter i by 1. Then, in step S303, the new base station 4 determines whether a counter value exceeds the number of available channels of the TV white space notified from the TVWSDB device 3 (i.e., Number Of Channels Available <i).

If “No” in step S303, in step S304, the new base station 4 configures synthesis settings. In the synthesis settings, the frequency is adjusted to a radio frequency of the available i-th channel notified by the TVWSDB device 3. Then, in step S305, the new base station 4 measures the RSSI (i.e., Received Electric Field Strength) at the adjusted frequency. Then, in step S306, the new base station 4 determines whether the measured RSSI is greater than, e.g., a predetermined specific value indicated by the standard or the like.

If “No” in step S306, the new base station 4 stores the channel as a vacant channel in a memory (e.g., measurement result table or the like) (not shown) in step S308, and the process returns to step S302.

On the other hand, if “Yes” in step S306, i.e., if it is a channel used by the radio system of an existing base station 5 and CPE terminals 6, the new base station 4 investigates whether the radio waves of the channel comply with IEEE 802.22 in step S307. Specifically, if the new base station 4 can receive the SCH transmitted from the existing base station 5 or the CBP burst transmitted from the CPE terminal 6 through the channel, it is determined that the radio waves of the channel comply with IEEE 802.22. Otherwise it is determined that the radio waves of the channel do not comply with IEEE 802.22.

In step S308, the new base station 4 stores, as measurement results, channel information, the RSSI of the channel and the investigation result of whether the cell of the channel is in IEEE 802.22 or not in a memory (not shown). That is, channel information on each channel, the RSSI of the channel, whether the channel is a vacant channel or not, and whether the cell of the channel complies with IEEE 802.22 or not in the case where the channel is not a vacant channel are stored as measurement results.

Then, the new base station 4 repeats the process from step S302 to step S308 until Number Of Channels Available <i is satisfied in step S303.

If “Yes” in step S303 (i.e., Number Of Channels Available <i), in step S309, the new base station 4 retrieves a vacant channel based on the stored measurement results. In step S310, the new base station 4 determines whether there is a vacant channel or not based on the retrieval result.

If “Yes” in step S310, in step S315, on the basis of the stored measurement results, the new base station 4 determines a channel of the lowest RSSI among vacant channels as an operation channel, and the process is completed. Further, as the RSSI of the channel is lower, the radio waves of the channel are clearer.

On the other hand, if “No” in step S310, in step S311, the new base station 4 retrieves whether there is cell complying with the IEEE 802.22 based on stored the measurement results. Then, in step S312, the new base station 4 determines whether there is the cell complying with the IEEE 802.22 based on the retrieval result.

If “Yes” in step S312, on the basis of stored the measurement results, the new base station 4 determines, as an operation channel, a channel of the highest RSSI among the channels of cells complying with IEEE 802.22 in step S314, and the process is completed. Further, in this case, the new base station 4 shares the channel with the existing base station 5. At this time, as the RSSI of the channel is higher, the channel is easier to perform time division. On the contrary, as the RSSI of the channel is lower, an exchange of a CBP protocol for sharing the channel between the new base station 4 and the existing base station 5 is worse.

Further, as described above, if the SCH from the existing base station 5 can be received in step S307, the existing base station 5 is stored as a base station complying with the same standard, i.e., IEEE 802.22 in step S308. Then, in step S314, if it has been determined that the channel of the existing base station 5 from which the SCH had been received is set as an operation channel, the existing base station 5 and the new base station 4 perform the process directly without the CPE terminal 6 instead of performing the process for sharing the radio channel via the CPE terminal 6 as shown in FIG. 4.

On the other hand, if “No” in step S312, i.e., if there is no cell complying with IEEE 802.22, the new base station 4 stops the operation in step S313, and the process is completed.

Thus, in the present embodiment, the TVWSDB device 3 retrieves the CPE terminal 6 which is closest to the new base station 4 in each channel corresponding to the position information of the new base station 4 to instruct only the retrieved CPE terminal 6 to transmit the CBP burst. Then, if there is no vacant channel, the new base station 4 finds the channel used by the radio system of the same standard as the new base station 4 to share the channel with the existing base station 5 via the CPE terminal 6 from which the CBP burst has been received. As a result, the new base station 4 can reliably detect the presence of the adjacent cell, and it is possible to prevent co-channel interference by excluding the hidden terminal problem.

To summarize the above,

(1) A radio system of the present invention comprises radio base stations to perform radio communication using a channel among channels, and terminal devices to perform radio communication with the radio base stations. The radio system further comprises a retrieving unit to retrieve a terminal device which is closest to a radio base station for each of one or more channels among the channels when determining a channel to be used by the radio base station, and an instructing unit to instruct the terminal device retrieved by the retrieving unit to transmit a notification signal. The radio base station comprises a channel determining unit to determine the channel to be used based on a reception state of the notification signal of the terminal device.

(2) Further, the channel determining unit of the radio base station may retrieve whether there is a vacant channel among the channels, if there is a vacant channel, determine the vacant channel as a channel to be used, and if there is no vacant channel, determine a channel of the notification signal or the control signal in the same standard as its own station as a channel to be used based on the received notification signal.

(3) Further, the channel determining unit of the radio base station may retrieve whether there is a vacant channel among the channels, if there is a vacant channel, determine the vacant channel as a channel to be used, and if there is no vacant channel, determine a channel of the notification signal or the control signal in the same standard as its own station as a channel to be used based on the received notification signal and/or the received control signal from other radio base stations.

(4) Further, the channel determining unit of the radio base station may determine that the channel is in the same standard as its own station if it is able to receive the notification signal, and determine that the channel is in a standard different from its own station if it is unable to receive the notification signal.

(5) Further, the radio base station may perform a setting process for sharing the channel with other radio base stations using the channel via the terminal device which has transmitted the notification signal when using the channel of the notification signal in the same standard as its own station.

(6) A radio base station of the present invention is a radio base station in a radio system comprising radio base stations to perform radio communication using a channel among channels, terminal devices to perform radio communication with the radio base stations, a retrieving unit to retrieve a terminal device which is closest to a radio base station for each of one or more channels among the channels when determining a channel to be used by the radio base station, and an instructing unit to instruct the terminal device retrieved by the retrieving unit to transmit a notification signal. The radio base station comprises a channel determining unit to determine the channel to be used based on a reception state of the notification signal of the terminal device.

(7) A management apparatus of the present invention is a management apparatus of a radio system comprising radio base stations to perform radio communication using a channel among channels and terminal devices to perform radio communication with the radio base stations, the radio base station comprising a channel determining unit to determine a channel to be used based on a reception state of a notification signal of the terminal device. The management apparatus comprises a retrieving unit to retrieve a terminal device which is closest to a radio base station for each of one or more channels among the channels when determining a channel to be used by the radio base station, and an instructing unit to instruct the terminal device retrieved by the retrieving unit to transmit a notification signal.

(8) The radio base station of the present invention is performs radio communications by sharing a channel between radio base stations and includes a channel determining unit to determine an operation channel based on a burst signal transmitted from a terminal which is closest to itself for each channel and share the operation channel with other radio base stations via a relay of the terminal between itself and the other radio base stations.

(9) Further, the channel determining unit may determine the channel of a cell in the same standard as its own station as the operation channel without setting the channel of a cell in a standard different from its own station as the operation channel.

(10) Further, the channel determining unit may determine that a cell is in the same standard as its own station if it is able to receive the burst signal, and determine that a cell is in a standard different from its own station if it is unable to receive the burst signal.

(11) The radio system of the present invention performs radio communications by sharing a channel between radio base stations and includes a channel determining unit to determine an operation channel based on a burst signal transmitted from a terminal which is closest to a radio base station for each channel and share the operation channel with other radio base stations via a relay of the terminal between the radio base station and the other radio base stations.

(12) Further, the channel determining unit may determine the channel of a cell in the same standard as the radio base station as the operation channel without setting the channel of a cell in a standard different from the radio base station as the operation channel.

(13) Further, the channel determining unit may determine that a cell is in the same standard as the radio base station if it is able to receive the burst signal, and determine that a cell is in a standard different from the radio base station if it is unable to receive the burst signal.

(14) A database device of the present invention has channel information available in a radio base station performing radio communications by sharing a channel between radio base stations and, for a channel determining unit to determine an operation channel based on a burst signal transmitted from a terminal which is closest to the radio base station for each channel and share the operation channel with other radio base stations via a relay of the terminal between the radio base station and the other radio base stations, retrieves a terminal which is closest to the radio base station for each channel available in the radio base station and instructs the other radio base stations such that the terminal transmits the burst signal.

(15) Further, each of the other radio base stations may schedule the terminal which is closest to the radio base station to periodically transmit a CBP burst.

The present invention is not limited to the above-described embodiment, and modifications may be made without departing from the scope of the invention. For example, even if the new base station has a standard (e.g., TD-LTE, or the like) other than the IEEE 802.22, the new base station can find a cell in the same standard as itself to share a channel. In the above-described embodiment, components having similar functions are denoted by the same reference numerals.

Further, in the above-described embodiment, the TVWSDB device 3 performs a retrieving process to retrieve the CPE terminal 6 transmitting the CBP burst in each channel, and an instructing process to instruct all the retrieved CPE terminals 6 to transmit CBP bursts, but the present invention is not limited thereto. For example, the TVWSDB device 3 may determine whether the CPE terminal 6 retrieved in the retrieving process is present in a predetermined range set in advance by the new base station 4, and issue an instruction to the existing base station 5 to which the position of the CPE terminal 6 present in the predetermined range is registered such that a CBP burst can be transmitted from only the CPE terminal 6 present in the predetermined range. Thus, it is possible to more efficiently obtain the effects similar to the embodiment described above.

Further, the TVWSDB device 3 may, first, retrieve the existing base station 5 in a predetermined adjacent range (i.e., in a range in which interference may occur) based on the position of the new base station 4, select the CPE terminal 6 which is closest to the new base station 4 among the CPE terminals 6 whose positions are registered in retrieved existing base stations 5 and allow at least the CPE terminal 6 to transmit the CBP burst. Also in this case, it is possible to more efficiently obtain the effects similar to the embodiment described above.

In the above embodiment and modifications described above, it has been described as an example that the TVWSDB device 3 functions as a management apparatus and performs a retrieving process to retrieve the CPE terminal 6 transmitting the CBP burst and an instructing process to instruct only the retrieved CPE terminal 6 to transmit the CBP burst. However, it may be configured such that the retrieving process and the instructing process are performed by a separate device from the TVWSDB device 3. For example, the TVWSDB device 3 may be configured to maintain only a database such that the retrieving process and the instructing process are performed by a device (the network management system 1, the network control system 2 or the like) which is provided separately and connected to the IP network 7. That is, the radio communications system of the present invention needs only to be provided with a means for performing the retrieving process and the instructing process.

Further, in the above-described embodiment, it has been described as an example that the new base station 4 and the existing base station 5 includes GPSs, acquires its own position information, and notifies the information with the TVWSDB device 3 to register it. However, the present invention is not limited thereto, and a position specifying means is not limited to the GPS. Further, the position information may not be acquired by the new base station 4 or the existing base station 5 to be notified/registered with the TVWSDB device 3. That is, in the present invention, it is preferable that the TVWSDB device 3 maintains the position information of the new base station 4 and the existing base station 5, and a method for maintaining the information is not limited in the present invention. Further, as in the above-described embodiment, as long as the TVWSDB device 3 retrieves the CPE terminal 6 which is closest to the new base station 4 for each channel and allows the retrieved CPE terminal 6 to transmit the burst, it is not necessary to use the position information of the new base station 4 or the existing base station 5.

In the above-described embodiment, a case where the new base station 4 is newly installed has been described as an example. However, the present invention is not limited to the case where the new base station 4 is newly added and may also be applied to a case of relocating the new base station 4 and the existing base station 5, performing a reset, or changing the used channel.

### INDUSTRIAL APPLICABILITY

The present invention may be widely applied to a radio system, a radio base station, and a management apparatus capable of performing radio communication by sharing a channel between radio base stations. For example, the present invention is preferably used in a system for performing radio communication by using a vacant channel (TV white space) in a television frequency band.

### DESCRIPTION OF REFERENCE NUMERALS

1 network management system
2 network control system
3 TVWSDB device
4 new base station
5 existing base station (5-1 to 5-m)
6 CPE terminal (6-1 to 6-1)
7 IP network
AP radio base station (AP1, AP2)

B shielding object

1. A radio system comprising:
a plurality of radio base stations for performing radio communications by using a channel among a plurality of channels;
a plurality of terminal devices for performing the radio communications with the radio base stations;
a retrieving unit for retrieving a terminal device which is closest to one of the radio base stations for each of one or more of the channels when determining a channel to be used by said one of the radio base stations; and
an instruction unit for instructing the terminal device retrieved by the retrieving unit to transmit a notification signal, and
wherein said one of the radio base stations includes a channel determining unit configured to determine the channel to be used based on a reception state of the notification signal from the terminal device.

2. The radio system of claim 1, wherein the channel determining unit searches for a vacant channel among the plurality of channels,
wherein the channel determining unit determines, when there is a vacant channel, the vacant channel as the channel to be used, and
wherein the channel determining unit determines, when there is no vacant channel, a channel of the notification signal which complies with a same standard that said one of the radio base stations complies with as the channel to be used based on the received notification signal.

3. The radio system of claim 1, wherein the channel determining unit determines, when the notification signal is received, that a standard which the notification signal complies with is same to what said one of the radio base stations complies with, and
wherein the channel determining unit determines, when the notification signal is not received, that the standard which the notification signal complies with is different from what said one of the radio base stations complies with.

4. The radio system of claim 2, wherein when using the channel of the notification signal which complies with the same standard that said one of the radio base stations complies with, said one of the radio base stations performs, via the terminal device from which the notification signal is transmitted, a setting process for sharing the channel to be used with other radio base stations using the channel to be used.

5. A radio base station for use in a radio system which includes:
a plurality of radio base stations for performing radio communications by using a channel among a plurality of channels;
a plurality of terminal devices for performing the radio communications with the radio base stations;
a retrieving unit for retrieving a terminal device which is closest to the radio base station for each of one or more of the channels when determining a channel to be used by the radio base station; and
an instruction unit for instructing the terminal device retrieved by the retrieving unit to transmit a notification signal, the radio base station comprising:
a channel determining unit configured to determine the channel to be used based on a reception state of the notification signal from the terminal device.

6. A management apparatus for use in a radio system which includes:
a plurality of radio base stations for performing radio communications by using a channel among a plurality of channels; and
a plurality of terminal devices for performing the radio communications with the radio base stations, at least one of the radio base stations containing a channel determining unit configured to determine a channel to be used based on reception state of one or more notification signals from one or more of the terminal devices, the management apparatus comprising:
a retrieving unit for retrieving a terminal device which is closest to one of the radio base stations for each of one or more of the channels when determining a channel to be used by said one of the radio base stations; and
an instruction unit for instructing the terminal device retrieved by the retrieving unit to transmit the notification signal.

7. The radio system of claim 2, wherein the channel determining unit determines, when the notification signal is received, that the standard which the notification signal complies with is same to what said one of the radio base stations complies with, and
wherein the channel determining unit determines, when the notification signal is not received, that the standard which the notification signal complies with is different from what said one of the radio base stations complies with.

8. The radio system of claim 3, wherein when using the channel of the notification signal which complies with the same standard that said one of the radio base stations complies with, said one of the radio base stations performs, via the terminal device from which the notification signal is transmitted, a setting process for sharing the channel to be used with other radio base stations using the channel to be used.

9. The radio system of claim 7, wherein when using the channel of the notification signal which complies with the same standard that said one of the radio base stations complies with, said one of the radio base stations performs, via the terminal device from which the notification signal is transmitted, a setting process for sharing the channel to be used with other radio base stations using the channel to be used.

10. The radio base station of claim 5, wherein the channel determining unit searches for a vacant channel among the plurality of channels,
wherein the channel determining unit determines, when there is a vacant channel, the vacant channel as the channel to be used, and
wherein the channel determining unit determines, when there is no vacant channel, a channel of the notification signal which complies with a same standard that the radio base station complies with as the channel to be used based on the received notification signal.

11. The radio base station of claim 5, wherein the channel determining unit determines, when the notification signal is received, that a standard which the notification signal complies with is same to what the radio base station complies with, and
wherein the channel determining unit determines, when the notification signal is not received, that the standard which the notification signal complies with is different from what the radio base station complies with.

12. The radio base station of claim 10, wherein the channel determining unit determines, when the notification signal is received, that a standard which the notification signal complies with is same to what the radio base station complies with, and
wherein the channel determining unit determines, when the notification signal is not received, that the standard which the notification signal complies with is different from what the radio base station complies with.

13. The radio base station of claim 10, wherein when using the channel of the notification signal which complies with the same standard that the radio base station complies with, the radio base station performs, via the terminal device from which the notification signal is transmitted, a setting process for sharing the channel to be used with other radio base stations using the channel to be used.

14. The radio base station of claim 11, wherein when using the channel of the notification signal which complies with the same standard that the radio base station complies with, the radio base station performs, via the terminal device from which the notification signal is transmitted, a setting process for sharing the channel to be used with other radio base stations using the channel to be used.

15. The radio base station of claim 12, wherein when using the channel of the notification signal which complies with the same standard that the radio base station complies with, the radio base station performs, via the terminal device from which the notification signal is transmitted, a setting process for sharing the channel to be used with other radio base stations using the channel to be used.
